(19) United States
(12) Patent Application Publication
(10) Pub. No.: US 2011/0017882 A1
(43) Pub. Date: Jan. 27, 2011

(54) HOSE HOLSTER

(76) Inventor: Todd G. Grunow, Port Orchard, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/506,858

(22) Filed: Jul. 21, 2009

(51) Int. Cl. F16M 13/00; A44B 21/00; A44B 18/00

(52) U.S. Cl. 248/79; 24/457; 24/303; 24/442; 248/75

(57) ABSTRACT

A mechanical apparatus for securely holding a hose, even while liquid is flowing through the hose, by creating a frictional force on the hose without kinking or otherwise restricting the flow through the hose. The apparatus includes a tube with a diameter suitably larger than the hose to be used with the apparatus. The tube includes a suitable bend such that the hose must bend as it passes through the tube. The apparatus also includes a bracket allowing the apparatus to be attached to, for example, a bucket or other suitable reservoir.

### BACKGROUND OF THE INVENTION

1. Field of the Invention

The present invention is directed generally to an apparatus for holding a hose and more specifically, for holding a hose in place while a liquid is flowing through the hose by overcoming the reaction force imposed on the hose by the flowing liquid.

2. Description of the Related Art

Hoses have many uses. For example, a garden hose might typically be used to deliver water from a spigot to a nozzle to water plants. Likewise, such a hose may be used to fill a reservoir such as a bucket or watering trough for livestock. If the delivery rate and pressure of water in the hose is kept low enough, there is generally little need to tend the hose while water flows. For example, one may place the end of the hose in a reservoir and turn on the spigot such that water flows very slowly through the hose. If, however, one wishes to turn on the spigot fully such that maximum flow through the hose is made possible, the reactive force on the hose created by the water flow will cause the hose to fly about, requiring the user to grasp the hose before turning on the water and while the water is flowing. One ordinarily learns early in life the consequence of carelessly turning on an untended hose. Such a situation is depicted in FIG. 1. Simply placing the hose 105 into the reservoir 110 and turning on the spigot 115 can result in the hose 105 wildly flailing about with water being projected virtually anywhere other than the reservoir 110, its intended location.

The tendency for the hose to act in this manner is due to what is known as Newton's Third Law of Motion. Newton's Third Law of Motion is typically stated as: for every action, there is an equal and opposite reaction. When water is flowing through a hose, the water pressure and the hose apply a force on the water such that the water is forced to flow in a certain direction as it exits the hose. Likewise, therefore, the water exerts the same force on the hose but in the opposite direction. Since the water is being projected from the end of the hose with a particular force, the same force is being applied to the nozzle of the hose in the opposite direction. Said another way, when the hose applies a force that acts on the water to cause the water to move away from the hose, an opposite force acts on the hose that causes the hose to try and move away from the water. Because a hose is not rigid, the result is an unstable collection of forces acting on the nozzle of the hose and causing such to flail about unpredictably as water is sprayed everywhere.

In cases where a hose is very large, the rate of water flow very high and/or the delivery pressure is very high, it can be very difficult to hold the hose in place. A typical example of this situation is a fire hose used to fight a fire. In this situation, it may require two, three, or even more firefighters to hold the hose in place so that water may be directed onto the fire. Although most uses of a hose to deliver water or other liquids are less extreme than this example, it will nevertheless be appreciated that there is a need for a device or apparatus that may tend the end of a hose such that the hose is controlled and held in place when liquid flows through the hose thereby eliminating the need for a person to tend the hose.

### BRIEF DESCRIPTION OF THE SEVERAL VIEWS OF THE DRAWING(S)

FIG. 1 is depicts a typical situation where a hose is untended and flowing water causes the hose to move about.

FIG. 2 depicts a hose holster according to an embodiment of the invention.

FIG. 3 depicts a cross-sectional view of a hose being used with the hose holster depicted in FIG. 2.

FIG. 4 depicts a typical use scenario of the hose holster of FIG. 2.

FIG. 5A depict a hose holster according to a first alternative embodiment of the invention.

FIG. 5B depict a hose holsters according to a second alternative embodiment of the invention.

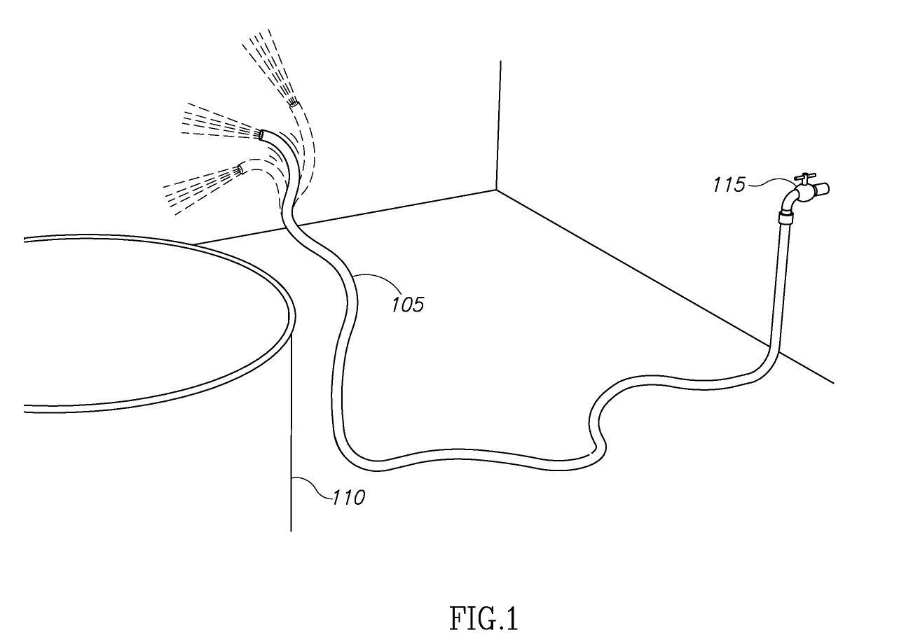

### DETAILED DESCRIPTION OF THE INVENTION

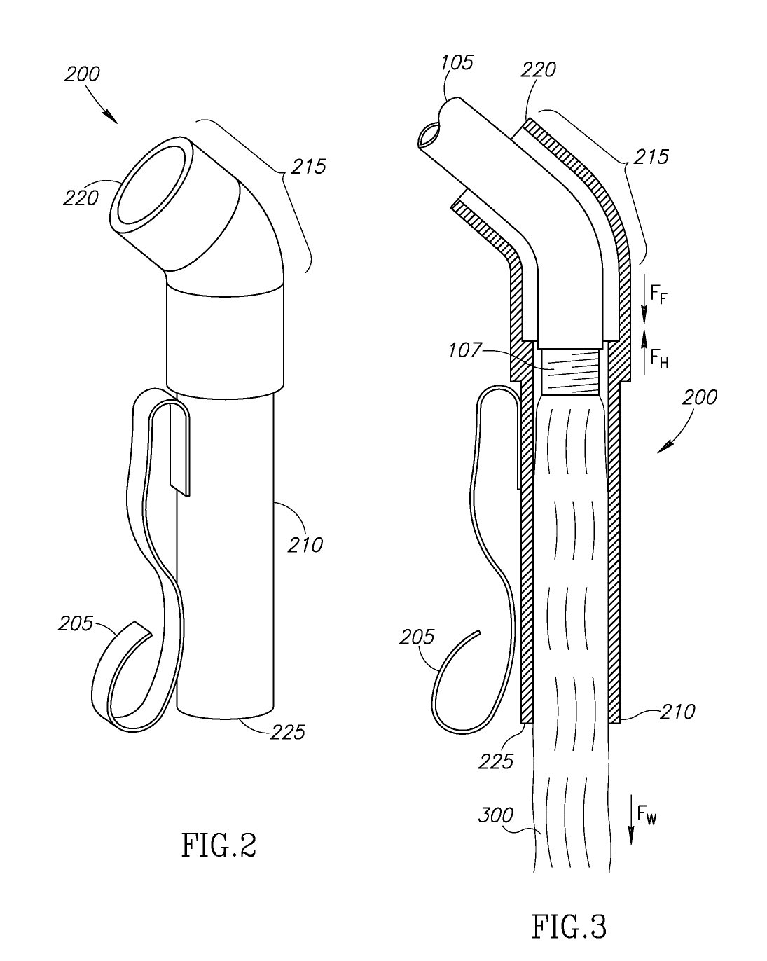

FIG. 2 depicts a hose holster 200 according to an embodiment of the invention. The hose holster 200 includes a straight section 210 of pipe coupled to an angled section 215 of pipe. The diameter of the sections 210 and 215 is chosen to accommodate the particular hose that is to be used with the hose holster 200. That is, and as will be described in more detail below, the hose must be able to fit into a mouth 220 of the angled section 215 of the hose holster 200, and be able to be pushed down through the hose holster 200 until the hose extends at least past the angled section 215. Alternatively, it can be extended until it comes out through a tail 225 of the straight section 210. Although, embodiments of the invention are described herein in terms of “pipe” and “diameter”, it will be understood that embodiments of the invention may use tubing or pipe, and that there is no need for the cross section of the tubing or pipe to be circular. The pipe 210 could have, for example, a square or rectangular cross section. Indeed, any shape of pipe cross section may be employed with embodiments of the invention so long as the hose may pass through the interior of the hose holster 200 from the mouth 220 to the tail 225. The hose holster 200 also includes a clip 205. The clip 205 allows the hose holster 200 to be placed on a reservoir, or other object, and thereby permit the hose holster 200, and the hose extending therethrough, to be held in place in or near the reservoir. Although depicted as a clip, it will be understood that other means may be employed to secure the hose holster 200 to a reservoir including any variety of clamp, magnet or hook-and-loop fasteners.

The mode of operation and importance of the angled section 215 of the hose holster 200 will now be discussed. FIG. 3 depicts a cross sectional view of the hose holster 200 wherein a hose 105 has been placed into the mouth 220 and pushed down past the angled section 215. After the water is turned on at the spigot (not shown in FIG. 3) the water begins to flow out of an end 107 of the portion of the hose 105 and is contained by the straight section 210 and channeled downward for exit from the tail 225 of the hose holster 200 and into the bucket, tub or other water reservoir to which the water is intended to be directed. The water 300 is projected out of the hose 105 by a force. The magnitude of force on the water is represented by F_{w}, and the downward pointing arrow shows the direction the force is acting. As was discussed above, a countervailing force Fₕ acts on the hose 105. The force Fₕ acting on the hose is of equal magnitude to that of F_{w}, but acts in the opposite direction. In order for the hose 105 to remain stationary when the force Fₕ is acting upon it, some other force must be imparted on the hose 105 to counter the force Fₕ. The force that opposes Fₕ and holds the hose 105 in place is provided by a force, labeled F_{f} in FIG. 3, which comprises a force component resulting from friction between the hose 105 and the interior wall of the angled section 215 and a force component resulting from the movement of the hose being blocked by engagement with the interior wall of the angled section. Said another way, the force Fₕ acting on the hose pushes the hose upwardly until the hose 105 comes into contact with the angled section 215. The force F_{f} counteracts the force Fₕ acting on the hose 105, and thereby establishes an equilibrium wherein the hose 105 is stationary while water is flowing out the end 107 of the hose.

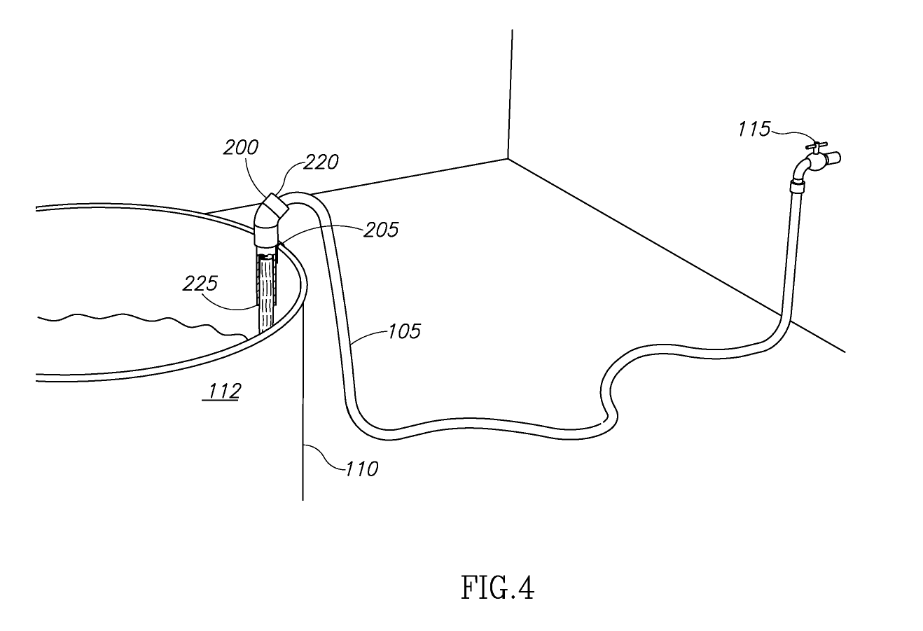

FIG. 4 depicts a typical use scenario of the hose holster 200 of FIG. 2. The hose holster 200 is placed on the side of the reservoir 110 using the clip 205 to attach it to a side 112 of the reservoir. The clip 205 must be attached to the reservoir securely enough to resist the force Fₕ discussed above lest the hose holster be lifted entirely off the reservoir by the hose. In one embodiment, the clip 205 may be a spring clip. In other embodiments, however, the clip 205 may comprise other means of securing the hose holster 200 to the reservoir including: a clamp, a bracket, a magnet or hook-and-loop fasteners. The hose 105 is placed into the mouth 220 of the hose holster 200 and pushed down until past the angled section 215, thus the water that exists out of the tail 225 is directed downward into the reservoir 110. The water may then be turned on at the spigot 115 and, as described above, the hose 105 will be held in place without the need for a person to tend to it while the water flows.

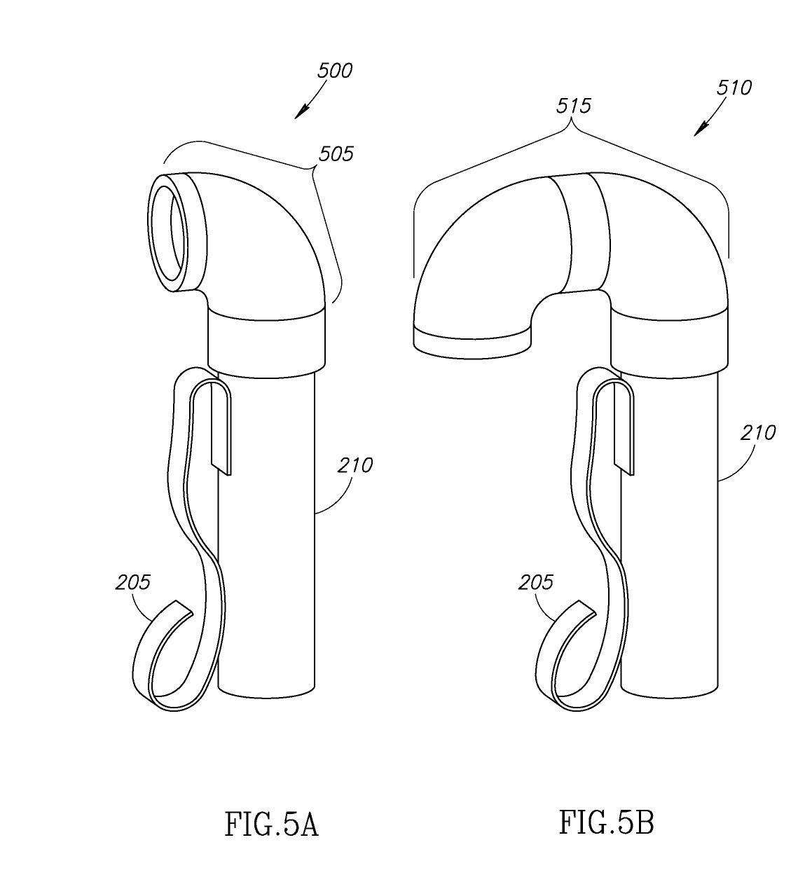

Although the angled section 215 of the hose holster 200 shown in FIG. 2 takes on approximately a 45 degree angle relative to the straight section 210, other angles are possible in alternative embodiments of the invention. FIGS. 5A and 5B depict hose holsters 500 and 510 according to two example alternative embodiments. The hose holster 500 of FIG. 5A features an angled section 505 that is approximately 90 degrees relative to the straight section 210. Such an embodiment may be useful where the volume and/or pressure of the water flowing through the hose creates a relatively larger force acting on the hose. In that situation, the additional length of the curvature of the angled section 505 will permit additional frictional force to be imparted on the hose and thereby offset the stronger force acting on the hose.

The hose holster of FIG. 5B depicts another embodiment of the invention with an angled section 515. The angled section 515 in this embodiment is approximately 180 degrees relative to the straight section 210. Again, such a configuration may prove useful in situations where there are large forces acting on the hose. The cross sectional area of the pipe used to construct the hose holster 510 may need to be somewhat larger for a given size hose than the embodiments discussed above. The larger cross sectional area may be required in order to feed the hose through the hose holster 510 since the frictional forces that hold the hose in place while water is flowing also serve to impede the placement of the hose within the holster. Indeed, it may prove beneficial to use a fish tape, or similar apparatus, to permit the hose to be simultaneously pulled and pushed through the hose holster 510 during installation of the hose.

Although the foregoing description is made in terms of “water” and a “spigot”, it will be appreciated that embodiments of the invention will function equally well with hoses carrying some other liquid and even where a spigot, as such, is not used or present. Likewise, although specific embodiments of the invention have been described herein for purposes of illustration, it will be understood by one skilled in the art that various modifications may be made without deviating from the invention. Accordingly, the invention is not limited except as by the appended claims.

1. An apparatus for securing a hose to a container to be filled with a fluid provided by the hose through an upwardly facing opening of the container, comprising:
a first tube having a straight section comprising a fluid-impervious cylindrical wall spaced between first and second ends arranged along a first longitudinal axis, the first and second ends having first and second openings, respectively;
a second tube having an arcuate section spaced between third and fourth ends, the third and fourth ends having third and fourth openings, respectively, the third end coupled to the first tube at its first end, the cross sectional area of at least the first, third and fourth openings each being greater than the lateral cross sectional area of the hose; and
an attaching member coupled to the first tube and configured to permit the apparatus to be attached to an upwardly extending sidewall of the container with the first tube extending through the upwardly facing opening of the container and the hose positioned in at least the second tube with the first tube aligned to direct the fluid from the hose into the container.

2. The apparatus of claim 1 wherein the first tube and the second tube are each selected from the group comprising: round tubing, square tubing and rectangular tubing.

3. The apparatus of claim 1 wherein the attaching member is selected from a group comprising: a clip, a clamp, a bracket, a magnet and hook-and-loop fasteners.

4. The apparatus of claim 1 constructed for use with the hose carrying fluid at a maximum pressure of M, wherein the degree of curvature of the arcuate section of the second tube is selected to prevent movement of the hose from within the first and second tubes when the pressure of the fluid is M or less.

5. The apparatus of claim 1 wherein the first tube and second tube are an integral unit formed in a single piece of tubing.

6. An apparatus for holding the end of a hose having a lateral cross sectional area, comprising:
a tube having a straight portion and a curved portion, each with an opening arranged at an end thereof, the cross sectional area of at least the opening arranged at the end of the curved portion being greater than the lateral cross sectional area of the hose; and
an attachment portion coupled to the tube and configured to attach the apparatus to an upwardly extending sidewall of an object configured for containing fluid.

7. The apparatus of claim 6 wherein the tube is selected from the group comprising: round tubing, square tubing and rectangular tubing.

8. The apparatus of claim 6 wherein the attachment portion is selected from a group comprising: a clip, a clamp, a bracket, a magnet and a hook-and-loop fastener.

9. The apparatus of claim 6 constructed for use with a hose carrying fluid at a maximum pressure of M, wherein the degree of curvature of the curved portion is selected to prevent movement of the hose from within the tube.

10. An apparatus for tending a hose to a reservoir having an upwardly extending sidewall and upwardly facing opening, the apparatus comprising:
a length of duct having an opening at each end thereof with a bent portion positioned therebetween, the openings being at an angle with respect to one another, one opening being large enough to allow the end of a hose to be passed therethrough and beyond the bent portion; and
an attachment portion coupled to the duct and configured to attach the apparatus to the upwardly extending sidewall of the reservoir with the duct extending through the upwardly facing opening of the reservoir.

11. The apparatus of claim 10 wherein the lateral cross section of the duct is selected from the group comprising: round, square and rectangular.

12. The apparatus of claim 10 wherein the attachment portion is selected from a group comprising: a clip, a clamp, a bracket, a magnet and a hook-and-loop fastener.

13. The apparatus of claim 10 constructed for use with a hose carrying fluid at a maximum pressure of M, wherein the angle formed between each opening is selected to prevent movement of the hose from within the duct.

14. An apparatus for holding the end portion of a hose capable of discharging a fluid in position to direct the discharged fluid into a container having an upwardly extending sidewall through an upwardly facing opening of the container, comprising:
a tube having a wall portion located to engage the hose and apply a counterforce thereto sufficient to prevent longitudinal movement of the hose from within the tube in response to the reactive force that the discharged fluid from the hose imparts on the hose; and
an attachment portion coupled to the tube and configured to removably attach the apparatus to the upwardly extending sidewall of the container, such that at least a portion of the tube is positioned adjacent an inner surface and below the top of the upwardly extending sidewall with the tube extending through the upwardly facing opening of the container with the end portion of the hose positioned to direct the discharged fluid into the container.

15. The apparatus of claim 14 wherein the tube is selected from the group comprising: round tubing, square tubing and rectangular tubing.

16. The apparatus of claim 14 wherein the attachment portion is selected from a group comprising: a clip, a clamp, a bracket, a magnet and a hook-and-loop fastener.
